(19) United States
(12) Patent Application Publication
(10) Pub. No.: US 2025/0234318 A1
(43) Pub. Date: Jul. 17, 2025

(54) REGISTRATION PENDING STATE

(71) Applicant: QUALCOMM Incorporated, San Diego, CA (US)

(72) Inventors: Amer CATOVIC, San Diego, CA (US); Bharat SHRESTHA, San Diego, CA (US); Alberto RICO ALVARINO, San Diego, CA (US); Haris ZISIMOPOULOS, London (GB)

(21) Appl. No.: 18/849,154

(22) PCT Filed: Apr. 28, 2023
(86) PCT No.: PCT/US2023/020368

§ 371 Date: Sep. 20, 2024

(30) Foreign Application Priority Data
May 25, 2022 (GR) 20220100437

(51) Int. Cl. H04W 60/04; H04W 12/06; H04W 84/06

(52) U.S. Cl. CPC H04W 60/04; H04W 12/06; H04W 84/06

(57) ABSTRACT

Various aspects of the present disclosure generally relate to wireless communication. In some aspects, a user equipment (UE) may transmit a registration request message. The UE may receive a registration pending message. The UE may enter a registration pending state. The UE may transmit a registration resume message based at least in part on one or more parameters associated with the registration pending message. The UE may receive a registration accept message or a registration reject message. Numerous other aspects are described.

### CROSS-REFERENCE TO RELATED APPLICATION

This patent application claims priority to Greek patent application No. 20220100437, filed on May 25, 2022, entitled “REGISTRATION PENDING STATE,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for using a registration pending state for user equipment registration in a non-terrestrial network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting a registration request message. The method may include receiving a registration pending message. The method may include entering a registration pending state. The method may include transmitting a registration resume message based at least in part on one or more parameters associated with the registration pending message. The method may include receiving a registration accept message or a registration reject message.

Some aspects described herein relate to a method of wireless communication performed by a non-terrestrial network (NTN) entity. The method may include receiving a registration request message from a UE. The method may include transmitting a registration pending message. The method may include performing an authentication procedure for the UE with a terrestrial network entity. The method may include receiving a registration resume message from the UE. The method may include transmitting a registration accept message or a registration reject message based at least in part on whether the UE is authenticated.

Some aspects described herein relate to a UE for wireless communication. The UE may include a memory and one or more processors coupled to the memory. The one or more processors may be configured to transmit a registration request message and receive a registration pending message. The one or more processors may be configured to enter a registration pending state. The one or more processors may be configured to transmit a registration resume message based at least in part on one or more parameters associated with the registration pending message. The one or more processors may be configured to receive a registration accept message or a registration reject message.

Some aspects described herein relate to an NTN entity for wireless communication. The NTN entity may include a memory and one or more processors coupled to the memory. The one or more processors may be configured to receive a registration request message from a UE. The one or more processors may be configured to transmit a registration pending message. The one or more processors may be configured to perform an authentication procedure for the UE with a terrestrial network entity. The one or more processors may be configured to receive a registration resume message from the UE. The one or more processors may be configured to transmit a registration accept message or a registration reject message based at least in part on whether the UE is authenticated.

Some aspects described herein relate to a non-transitory computer-readable medium that stores a set of instructions for wireless communication by a UE. The set of instructions, when executed by one or more processors of the UE, may cause the UE to transmit a registration request message. The set of instructions, when executed by one or more processors of the UE, may cause the UE to receive a registration pending message. The set of instructions, when executed by one or more processors of the UE, may cause the UE to enter a registration pending state. The set of instructions, when executed by one or more processors of the UE, may cause the UE to transmit a registration resume message based at least in part on one or more parameters associated with the registration pending message. The set of instructions, when executed by one or more processors of the UE, may cause the UE to receive a registration accept message or a registration reject message.

Some aspects described herein relate to a non-transitory computer-readable medium that stores a set of instructions for wireless communication by an NTN entity. The set of instructions, when executed by one or more processors of the NTN entity, may cause the NTN entity to receive a registration request message from a UE. The set of instructions, when executed by one or more processors of the NTN entity, may cause the NTN entity to transmit a registration pending message. The set of instructions, when executed by one or more processors of the NTN entity, may cause the NTN entity to perform an authentication procedure for the UE with a terrestrial network entity. The set of instructions, when executed by one or more processors of the NTN entity, may cause the NTN entity to receive a registration resume message from the UE. The set of instructions, when executed by one or more processors of the NTN entity, may cause the NTN entity to transmit a registration accept message or a registration reject message based at least in part on whether the UE is authenticated.

Some aspects described herein relate to an apparatus for wireless communication. The apparatus may include means for transmitting a registration request message. The apparatus may include means for receiving a registration pending message. The apparatus may include means for entering a registration pending state. The apparatus may include means for transmitting a registration resume message based at least in part on one or more parameters associated with the registration pending message. The apparatus may include means for receiving a registration accept message or a registration reject message.

Some aspects described herein relate to an apparatus for wireless communication. The apparatus may include means for receiving a registration request message from another apparatus. The apparatus may include means for transmitting a registration pending message. The apparatus may include means for performing an authentication procedure for the other apparatus with a terrestrial network entity. The apparatus may include means for receiving a registration resume message from the other apparatus. The apparatus may include means for transmitting a registration accept message or a registration reject message based at least in part on whether the other apparatus is authenticated.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of a regenerative satellite deployment and an example of a transparent satellite deployment in a non-terrestrial network (NTN), in accordance with the present disclosure.

FIGS. 5A and 5B are diagrams illustrating an example of an existing registration procedure, in accordance with the present disclosure.

FIGS. 6A and 6B are diagrams illustrating an example of using a registration pending state, in accordance with the present disclosure.

FIG. 7 is a diagram illustrating an example process performed, for example, by a UE, in accordance with the present disclosure.

FIG. 8 is a diagram illustrating an example process performed, for example, by an NTN entity, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

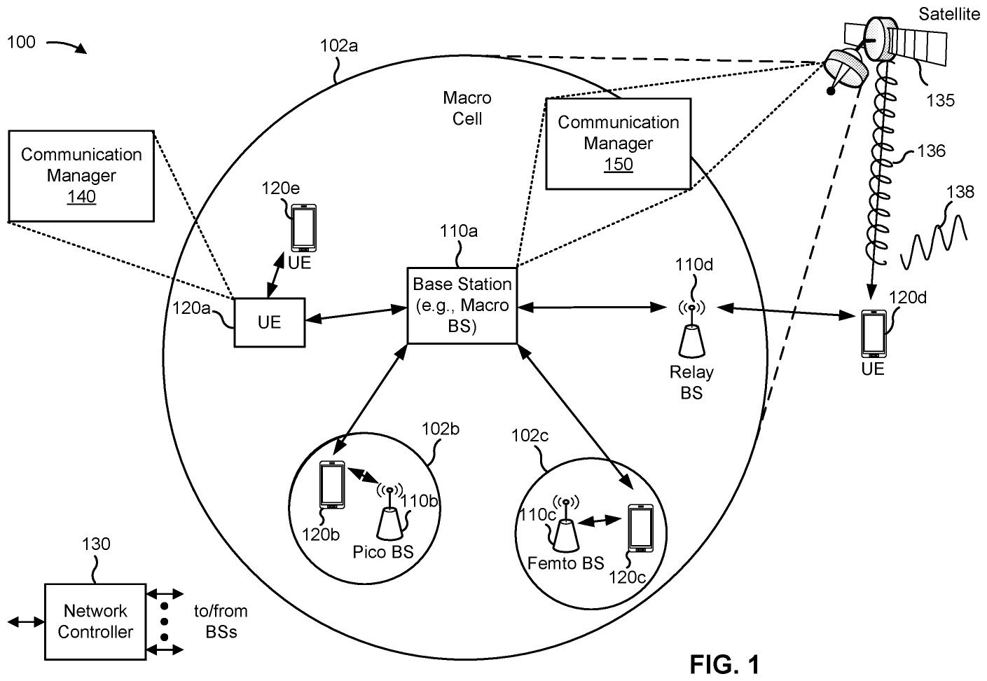

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

In some aspects, as shown, a cell may be provided by a network entity (e.g., base station 110) of a non-terrestrial network (NTN). As used herein, “non-terrestrial network” may refer to a network for which access is provided by a non-terrestrial base station, such as a base station carried by a satellite, a balloon, a dirigible, an airplane, an unmanned aerial vehicle, and/or a high altitude platform station. A network entity in an NTN (NTN network entity) may use a polarization. For example, a network entity in a satellite 135 (NTN network entity) may transmit a communication to the UE 120 using a circular polarization 136 or a linear polarization 138. Circular polarization occurs when the tip of the electric field of an electromagnetic wave at a fixed point in space traces a circle, and the electromagnetic wave may be formed by superposing two orthogonal linearly polarized waves of equal amplitude and a 90-degree phase difference. A circular polarization may be a right-hand circular polarization (RHCP) or a left-hand circular polarization (LHCP). Linear polarization occurs when the tip of the electric field of an electromagnetic wave at a fixed point in space oscillates along a straight line over time.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit a registration request message and receive a registration pending message. The communication manager 140 may enter a registration pending state. The communication manager 140 may transmit a registration resume message based at least in part on one or more parameters associated with the registration pending message and receive a registration accept message or a registration reject message. Additionally, or alternatively, the communication manager 140 may perform one or more other operations described herein.

In some aspects, an NTN network entity (e.g., base station 110, a network entity, satellite 135) may include a communication manager 150. As described in more detail elsewhere herein, the communication manager 150 may receive a registration request message from a UE and transmit a registration pending message. The communication manager 150 may perform an authentication procedure for the UE with a terrestrial network entity. The communication manager 150 may receive a registration resume message from the UE and transmit a registration accept message or a registration reject message based at least in part on whether the UE is authenticated. Additionally, or alternatively, the communication manager 150 may perform one or more other operations described herein.

As indicated above, FIG. 1 is provided as an example. Other examples may differ from what is described with regard to FIG. 1.

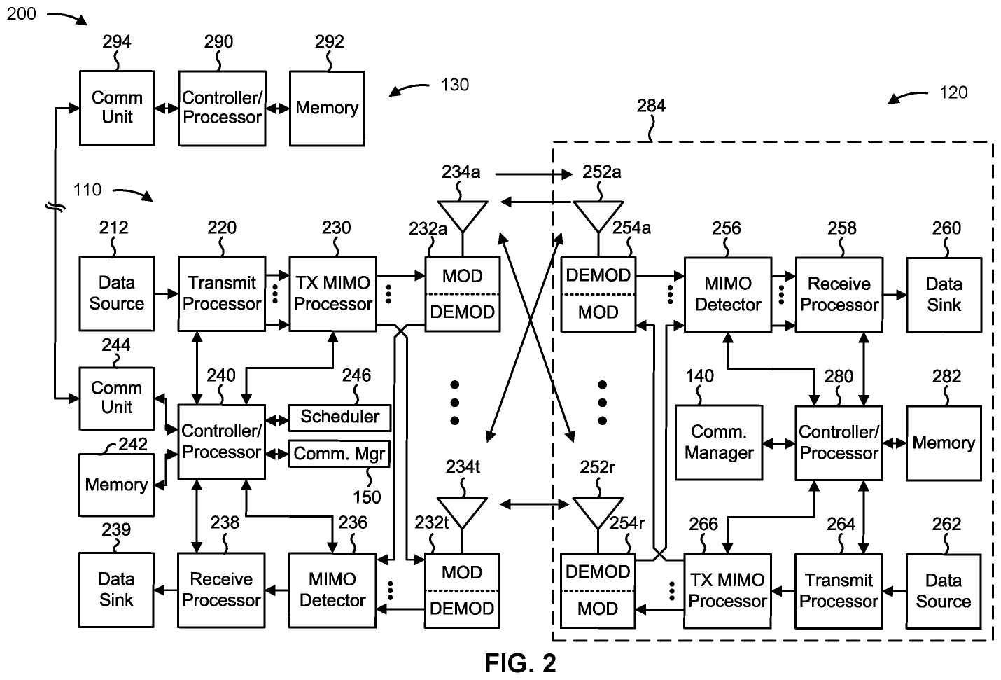

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t. The base station 110 may be an NTN network entity located in a terrestrial location or in a non-terrestrial location (e.g., satellite 135).

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

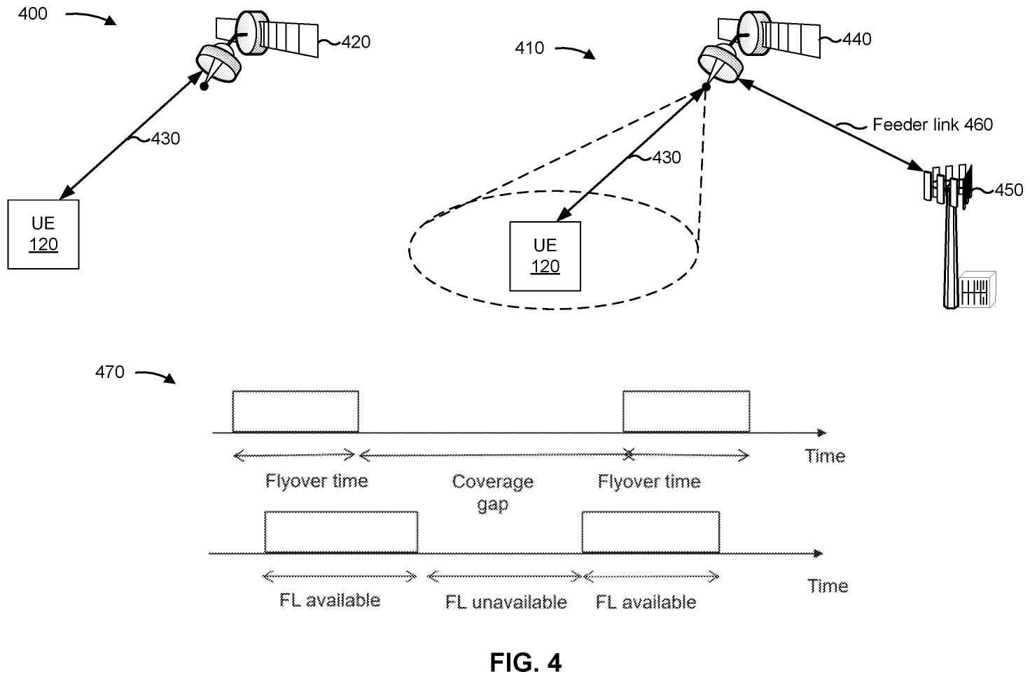

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

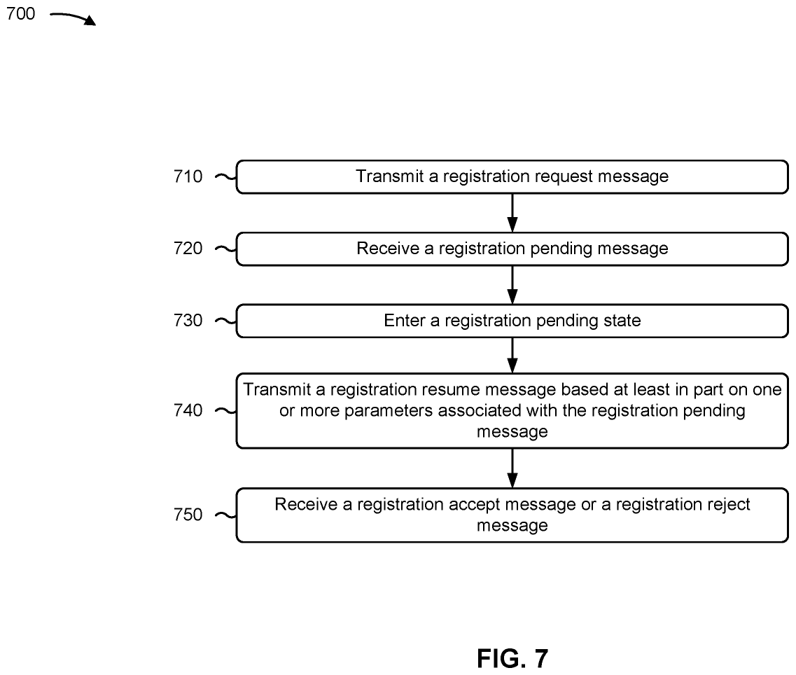

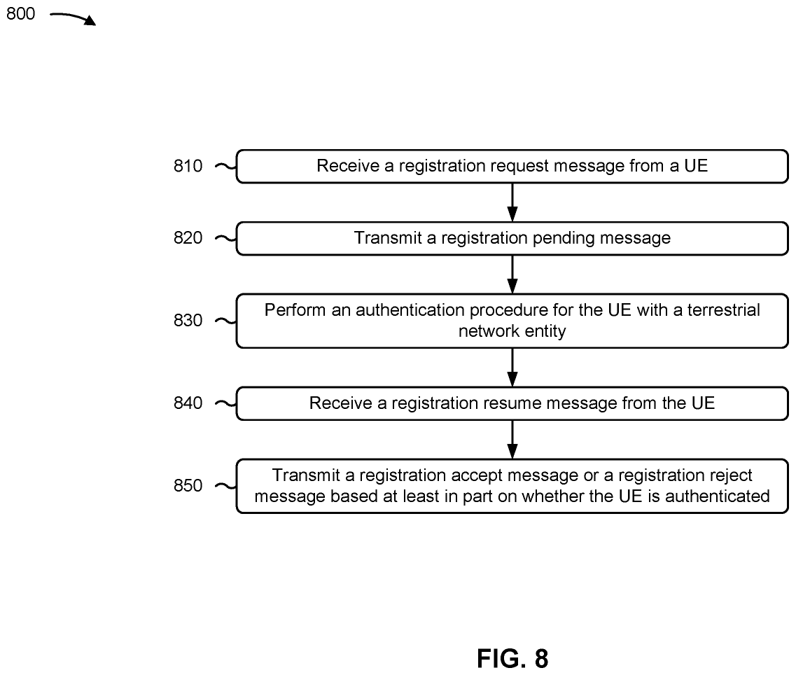

A controller/processor of a network entity, (e.g., the controller/processor 240 of the base station 110), the controller/processor 280 of the UE 120, and/or any other component(s) of FIG. 2 may perform one or more techniques associated with using a registration pending state in an NTN, as described in more detail elsewhere herein. In some aspects, the NTN entity is a network entity at the surface or at a satellite (e.g., 135). For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for transmitting a registration request message; means for receiving a registration pending message; means for entering a registration pending state; means for transmitting a registration resume message based at least in part on one or more parameters associated with the registration pending message; and/or means for receiving a registration accept message or a registration reject message. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an NTN entity (e.g., a base station 110, a network entity, satellite 135) includes means for receiving a registration request message from a UE; means for transmitting a registration pending message; means for performing an authentication procedure for the UE with a terrestrial network entity; means for receiving a registration resume message from the UE; and/or means for transmitting a registration accept message or a registration reject message based at least in part on whether the UE is authenticated. In some aspects, the means for the NTN entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

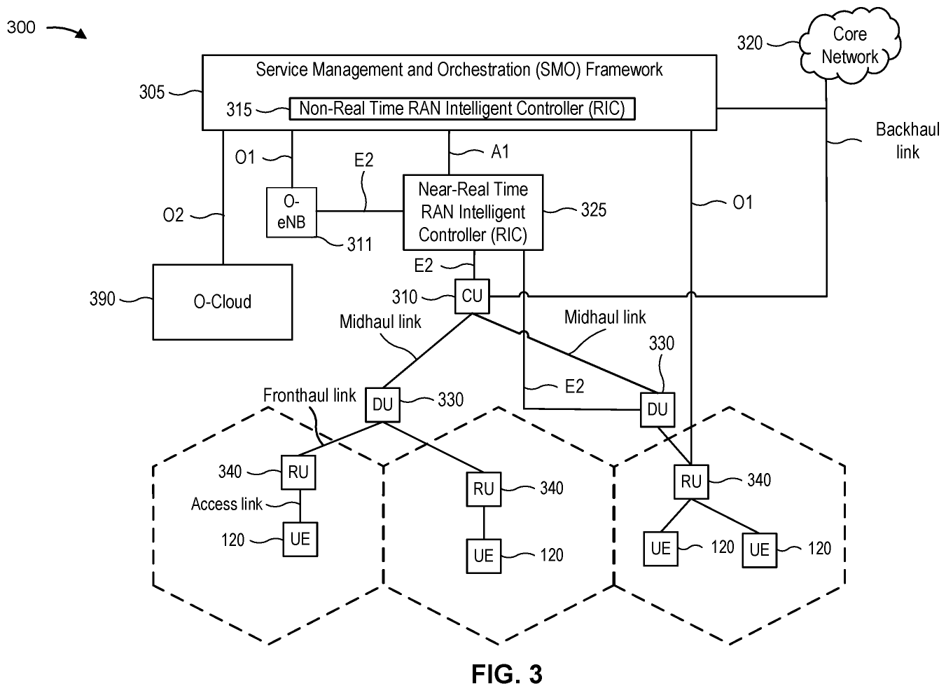

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of a regenerative satellite deployment and an example 410 of a transparent satellite deployment in an NTN, in accordance with the present disclosure.

Example 400 shows a regenerative satellite deployment. In example 400, a UE 120 is served by a satellite 420 (e.g., satellite 135) via a service link 430. For example, the satellite 420 may include a network entity (e.g., a base station 110, BS 110a, a gNB). In some aspects, the satellite 420 may be referred to as a non-terrestrial base station, a regenerative repeater, an on-board processing repeater, and/or an NTN entity. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may also be considered to be an NTN entity. The satellite 440 may be a transparent satellite. The satellite 440 may relay a signal received from gateway 450 via a feeder link 460. For example, the satellite may receive an uplink radio frequency transmission and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460 and may amplify and/or filter the uplink radio frequency transmission. In some aspects, the UEs 120 shown in example 400 and example 410 may be associated with a Global Navigation Satellite System (GNSS) capability, a Global Positioning System (GPS) capability, and/or the like, though not all UEs have such capabilities. The satellite 440 may provide a cell that covers the UE 120.

The service link 430 may include a link between the satellite 440 and the UE 120 and may include one or more of an uplink or a downlink. The feeder link 460 may include a link between the satellite 440 and the gateway 450 and may include one or more of an uplink (e.g., from the UE 120 to the gateway 450) or a downlink (e.g., from the gateway 450 to the UE 120).

The feeder link 460 and the service link 430 may each experience Doppler effects due to the movement of the satellites 420 and 440 and, potentially, movement of a UE 120. These Doppler effects may be significantly larger than in a terrestrial network. The Doppler effect on the feeder link 460 may be compensated to some degree but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 120 to drift from a target downlink frequency.

Satellites 420 and 440 may be a satellite in a geostationary orbit (GSO) or geosynchronous equatorial orbit (GEO), which may be, for example, 36,000 kilometers (km) above the earth. The speed of the satellite with respect to earth may be negligible but have a propagation delay of more than 500 milliseconds (ms), as compared to 25 ms for a low earth orbit (LEO) satellite at 600 km above the earth. In an NTN, where a distance between UE 120 and a satellite can be larger than 600 km, a pathloss change may not be appropriately reflected in a propagation delay change. The UE 120 is expected to be able to autonomously pre-compensate for propagation delay all the way to a reference point, and thus timing advance (TA) validation can be carried out more directly rather than relying on indirect parameters such as RSRP. The UE 120 may use a TA for timing alignment of communications due to a propagation delay. The TA may inform the UE 120 to transmit a communication earlier than scheduled by the TA amount. The TA may need to be validated if the propagation distance between the UE 120 and the network entity changes. In addition, a satellite may not be always available to the UE 120 if the satellite is in a non-geostationary orbit (NGSO).

Some satellite operators may deploy satellite access with intentional coverage gaps, or discontinuous coverage (DC). DC may be involve LEO satellites, IoT networks, or a satellite constellation that does not cover a particular location on Earth all of the time. Some services may be delay tolerant and may use DC. Such services may include services for IoT devices and networks, services for utility meters, or services that use sensors. DC may be used to address service availability and power consumption. In addition to DC, the feeder link 460 may have intermittent connectivity with a ground station, such as gateway 450. There may be some areas where it is not feasible to deploy a ground station, either due to deployment designs and/or costs.

Example 470 shows how an NTN network may experience unavailability of the feeder link 460 (FL) in addition to coverage gaps between consecutive flyovers above the ground station. For example, a cell size may range from 100 km to 1000 km, and a flyover time for a stationary UE may be 30 seconds to 5 minutes. A coverage gap could then be between 2 to 15 hours. However, when coverage is available, the feeder link 460 may be unavailable. While the NTN will likely be aware of an unavailability schedule for the feeder link 460, the UE 120 and the NTN may not be aware of the coverage gap schedule.

To deal with unavailability of the feeder link 460, a satellite transmitter may include network elements at the satellite 420/440. Both the radio network and the core network aspects may be mounted on the satellite 420/440. In one scenario, the entire control plane and user plane paths may be mounted on the satellite 420/440. For example, the control plane management entity (e.g., mobile management entity (MME) in 4G or an access and mobility management function (AMF) and a session management function (SMF) in NR) as well as the user plane path (e.g., serving gateway (GW) and packet data network GW for 4G or a user plane function in NR) may be mounted on the satellite 420/440. In this scenario, the ground station (e.g., gateway 450) may include the home subscriber services (HSS) including subscription management, user authentication and authorization. Also, in this scenario, some portions of the control plane path can be at the ground station (e.g., coordination between the control plane management entities in different satellites, buffering of user data and control plane data while FL is unavailable). In this scenario, there may also be user data plane and control plane data buffering at the satellite due to DC. Finally, the internet connection for the data plane may be at the ground station. Other functional splits between the satellite transmitter, and the ground station may be employed.

As indicated above, FIG. 4 is provided as an example. Other examples may differ from what is described with regard to FIG. 4.

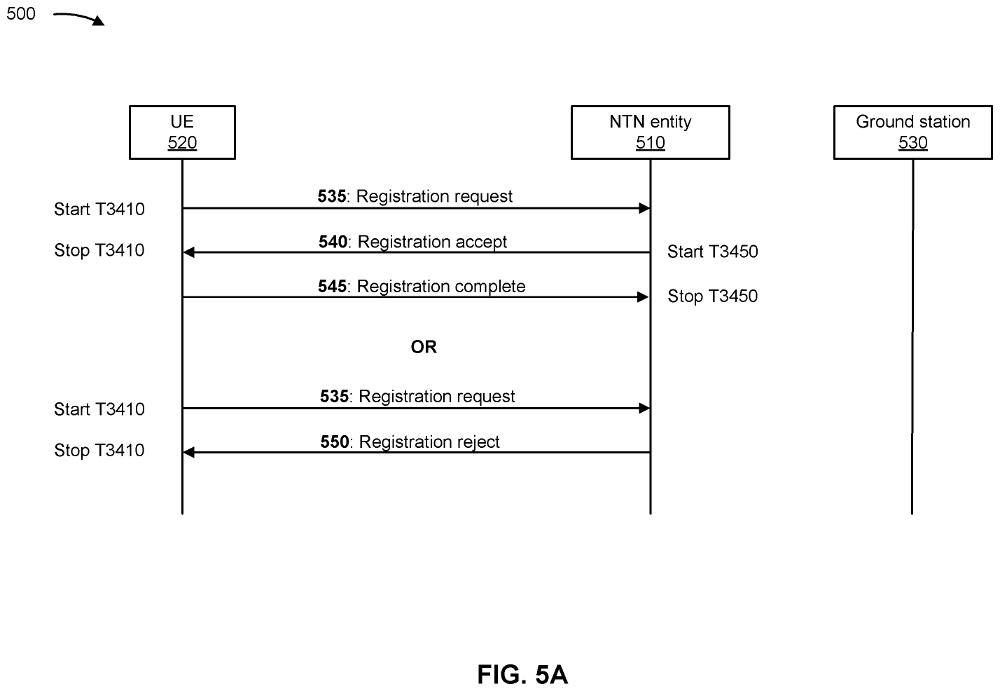

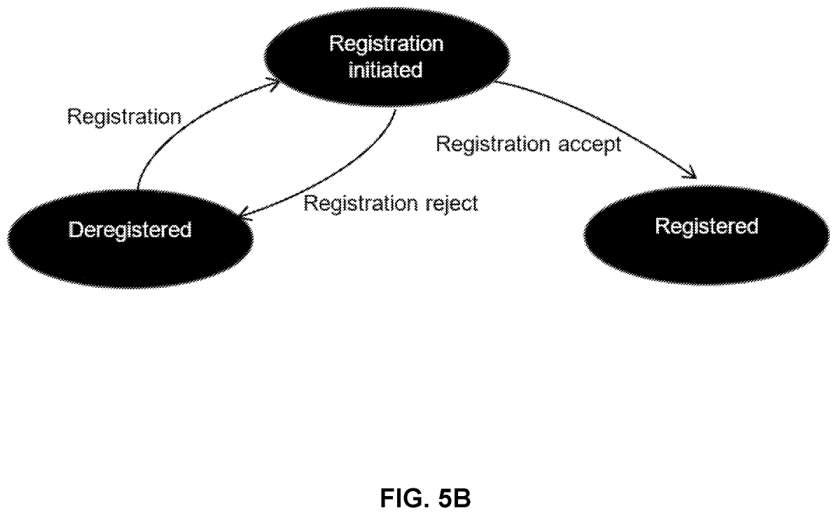

FIG. 5A is a diagram illustrating an example 500 of an existing registration procedure, in accordance with the present disclosure. As shown in FIG. 5A, an NTN entity 510 (e.g., base station 110, network entity, satellite 420, satellite 440) and a UE 520 (e.g., UE 120) may communicate with one another. The UE 520 and a terrestrial network entity (e.g., ground station 530) may communicate via the NTN entity 510.

Example 500 in FIG. 5A shows that UE 520 may successfully or unsuccessfully register with an NTN network. The UE 520 may initiate a registration procedure with the NTN during flyover. The registration procedure may include an attachment procedure to attach the UE 520 to the NTN network. In some signaling protocol implementations, registration may be referred to as “attachment”.

As shown by reference number 535, the UE 520 may transmit a registration request message. This may start a timer (e.g., T3410). In a successful scenario, the NTN entity 510 may transmit a registration accept message, as shown by reference number 540. This may stop the timer. As shown by reference number 545, the UE 520 may transmit a registration complete message.

FIG. 5B shows registration states and registration messages of an existing registration procedure. For example, the UE 520 may be in a deregistered state and transmit a registration message, such as a registration request. Registration is initiated. If registration is successful, the UE 520 may receive a registration accept message and enter a registered state. If registration is unsuccessful, the UE 520 may receive a registration reject message and remain in the deregistered state.

The NTN entity 510 may need to contact the ground station 530 to complete a registration procedure, or other procedures depending on the functional split between the NTN entity 510 and the ground station 530. The authentication procedure may include a handshake with the HSS at the ground station 530 to authenticate or authorize the user of the UE 520. However, the feeder link 460 may not be available at the time, and the registration request will be rejected due to the inability of the NTN entity 510 to complete the authentication procedure with the ground station 530. Accordingly, the NTN entity 510 may transmit a registration reject message, as shown by reference number 550. The UE 520 will have to attempt registration again at a time when the feeder link 460 is available. In some scenarios, the NTN entity 510 may act on the first registration request and prepare the necessary information (e.g., authentication vectors from the HSS) for when the feeder link 460 becomes available and the UE 520 retries registration (during a subsequent flyover). As a result, if the authentication procedure is reattempted, the authentication procedure may be completed even if the feeder link 460 is not available during the second flyover.

Current solutions to address feeder link and coverage issues during UE registration are suboptimal, increase latency, and involve extra processing resources and signaling resources. For example, rejection of the UE 520 includes a complete reset of the registration procedure for the UE 520 and the UE 520 does not receive information about the reason for the rejection. At the next flyover period, the UE 520 has to start from the beginning, providing all of the same registration information in another registration request. The user of the UE 520 is not provided information about what is happening with the failed registration and about any new attempt to register. The UE 520 does not have any additional information to help the UE 520 to determine when to retry registration. The rejection of the UE 520 also involves a reset of the registration procedure for the NTN entity 510. While the NTN entity 510 may perform some operations to help the UE 520 to be successful in the next attempt, the UE 520 maintains its deregistered status. When the UE 520 is in the deregistered status, incoming connection requests for the UE 520 are rejected. This increases latency and wastes processing resources and signaling resources for other devices.

As indicated above, FIGS. 5A and 5B are provided as examples. Other examples may differ from what is described with regard to FIGS. 5A and 5B.

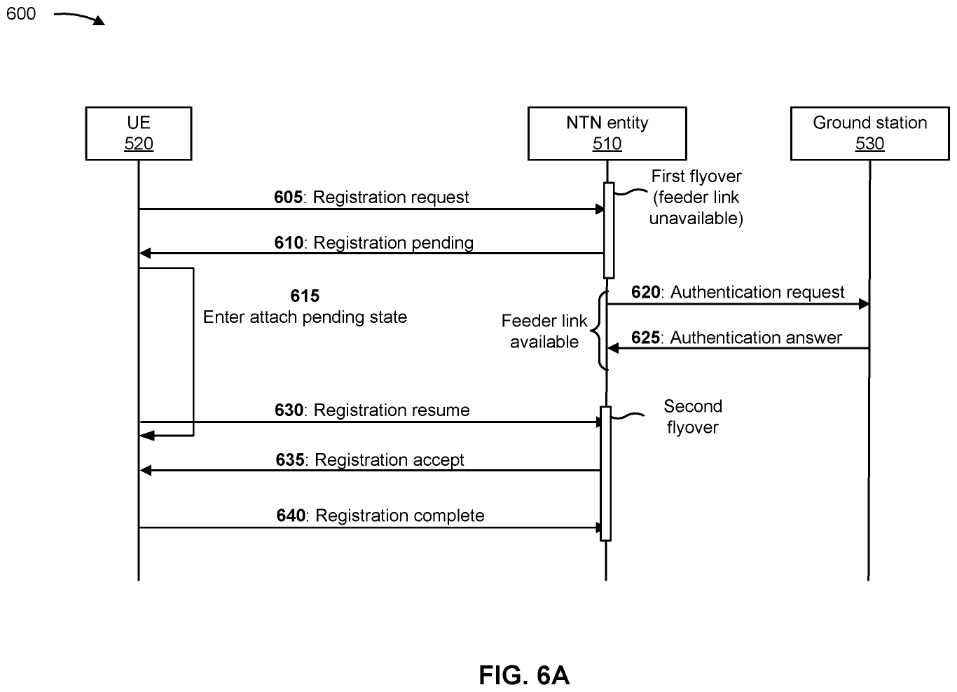

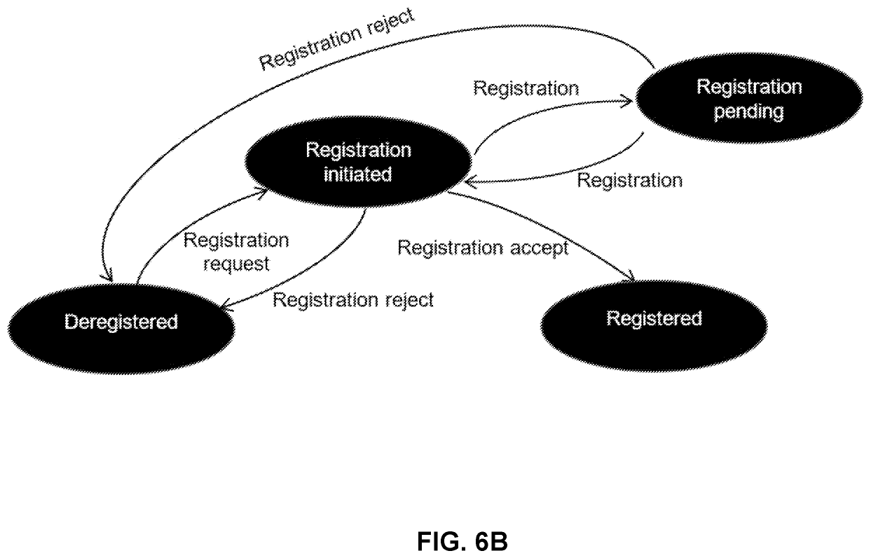

FIG. 6A is a diagram illustrating an example 600 of using a registration pending state, in accordance with the present disclosure.

According to various aspects described herein, the UE 520 may enter a registration pending state that gives the NTN entity 510 an opportunity to await authentication by the NTN entity 510 if there is a coverage gap (between flyovers) and/or the feeder link 460 is unavailable. In this way, a full reset of the registration procedure is prevented, which reduces latency and conserves processing resources and signaling resources of the UE 520 and other devices.

As shown by reference number 605, the UE 520 may transmit a registration request message. This may be part of a first flyover by the NTN entity 510. As shown by reference number 610, the NTN entity 510 may transmit a registration pending message. The NTN entity 510 may transmit the registration pending message if the feeder link 460 is not available. As shown by reference number 615, the UE 520 may enter a registration pending state in response to receiving the registration pending message. The UE 520 may indicate the registration pending state to the user of the UE 520 (e.g., via display on a display screen of the UE 520) and/or to other devices requesting connection. When the UE 520 is in the registration pending state, connection requests initiated by the user or applications may be rejected locally in the UE 520 without initiating the signaling procedure with the NTN entity 510. The user or the application initiating the connection request may be informed about the reason for the connection request rejection (e.g., due to a registration pending state).

In some aspects, the registration pending message may include or may be associated with one or more parameters that are specified for use of the registration pending state. For example, one parameter may be a time duration for the registration pending state. The UE 520 may start a timer that is set to the time duration. The UE 520 may wait until the timer expires before transmitting a registration resume message. The time duration may be associated with the timer until the next availability of the feeder link connection. The UE 520 may also receive and store the parameters from an earlier configuration. The NTN entity 510 may also enter a registration pending state and store parameters or information received in the registration request message with UE identification information, such as a first identifier (ID) and/or a second ID that is associated with the first ID and that may be a permanent ID (e.g., subscriber ID).

In some aspects, the registration pending message may include a reason for the registration pending message, such as the feeder link 460 being unavailable or the NTN entity 510 being out of coverage from an authenticating ground station such as ground station 530. The UE 520 may display this reason to the user of the UE 520 or indicate the reason to other devices or applications. The NTN entity 510 may also provide this reason to requesting devices. The NTN entity 510 may buffer incoming connection requests and process the connection requests after the registration is completed.

As shown by reference number 620, the NTN entity 510 may transmit an authentication request message to the ground station 530, which may host or be connected to an HSS, an AMF, an SMF, or another authentication function. As shown by reference number 625, the ground station 530 may transmit an authentication answer, whether the authentication is successful or not. This occurs when the feeder link 460 is available.

As shown by reference number 630, the UE 520 may transmit a registration resume message to resume the registration procedure. This may be during a second flyover. The UE 520 may transmit the registration resume message based at least in part on the reason, expiration of the timer, a flyover schedule, a feeder link schedule, and/or a detected change in traffic or channel conditions. In some aspects, the UE 520 may use the first ID as a temporary ID for extra security. The first ID and/or the second ID may be specific to the registration resume message. For example, the first ID may be used only for the registration resume message. The registration resume message may also include just a subset of the parameters or just a subset of the information included in the registration request message. The NTN entity 510 may identify the UE 520 based at least in part on the first ID.

In some aspects, transmitting the registration pending message may include creating a record of the UE 520 in a database and associating the record of the UE 520 with a registration pending state. The NTN entity 510 may create the first ID for the UE 520 and associate the record of the UE 520 with the first ID of the UE 520. The NTN entity 510 may identify the UE 520 by retrieving a record of the UE 520 from a database based at least in part on the first ID in the registration resume message.

If registration is successful (e.g., successful authentication), the NTN entity 510 may transmit a registration accept message, as shown by reference number 635. As shown by reference number 640, the UE 520 may transmit a registration complete message. By using the registration pending state, the UE 520 may conserve processing resources and signaling resources. Alternatively, if the registration procedure is unsuccessful (e.g., timed out, unsuccessful authentication), the NTN entity 510 may transmit a registration reject message.

FIG. 6B shows registration states and registration messages using a registration pending state. For example, the UE 520 may be in a deregistered state and transmit a registration message, such as a registration request message. Once registration is initiated, the UE 520 may enter a registration pending state after receiving a registration pending message. Authentication make take place while the UE 520 is in the registration pending state. The registration procedure may resume when the UE 520 transmits a registration resume message.

If registration is successful, the UE 520 may receive a registration accept message and enter a registered state. If registration is unsuccessful, the UE 520 may receive a registration reject message and remain in the deregistered state.

In some aspects, the UE 520 may indicate whether use of the registration pending state is acceptable or not. That is, the UE 520 may be configured for the registration pending state and may determine to use the registration pending state or to not use the registration pending state. If the UE 520 indicates that the registration pending state is not acceptable (e.g., not configured for using the registration pending state or determined not to use the registration pending state), the NTN entity 510 may reject the UE 520 and not use the registration pending state. This may be the case for real-time services, emergency calls, or other time-sensitive applications.

As indicated above, FIGS. 6A and 6B are provided as examples. Other examples may differ from what is described with regard to FIGS. 6A and 6B.

FIG. 7 is a diagram illustrating an example process 700 performed, for example, by a UE, in accordance with the present disclosure. Example process 700 is an example where the UE (e.g., a UE 120, UE 520) performs operations associated with using a registration pending state in an NTN.

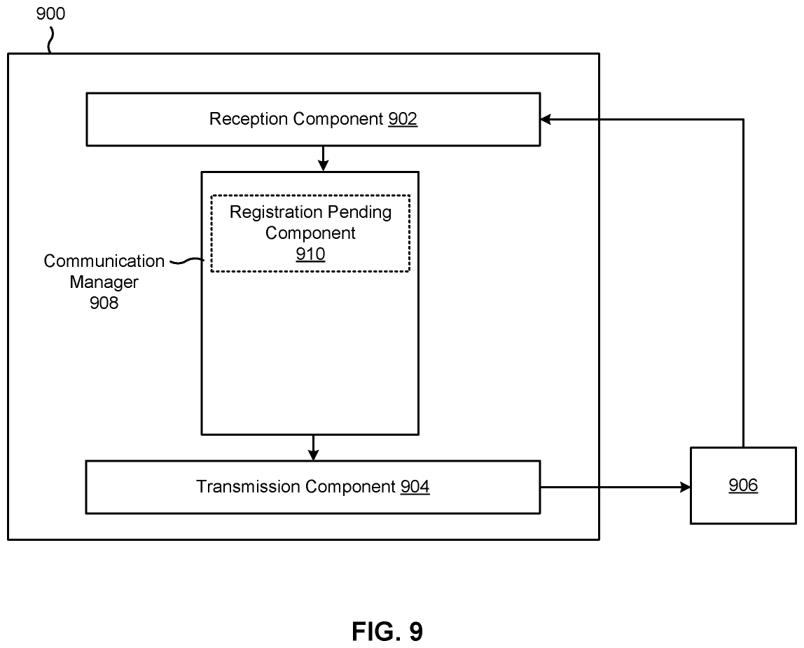

As shown in FIG. 7, in some aspects, process 700 may include transmitting a registration request message (block 710). For example, the UE (e.g., using communication manager 908 and/or transmission component 904 depicted in FIG. 9) may transmit a registration request message, as described above.

As further shown in FIG. 7, in some aspects, process 700 may include receiving a registration pending message (block 720). For example, the UE (e.g., using communication manager 908 and/or reception component 902 depicted in FIG. 9) may receive a registration pending message, as described above.

As further shown in FIG. 7, in some aspects, process 700 may include entering a registration pending state (block 730). For example, the UE (e.g., using communication manager 908 and/or registration pending component 910 depicted in FIG. 9) may enter a registration pending state, as described above.

As further shown in FIG. 7, in some aspects, process 700 may include transmitting a registration resume message based at least in part on one or more parameters associated with the registration pending message (block 740). For example, the UE (e.g., using communication manager 908 and/or transmission component 904 depicted in FIG. 9) may transmit a registration resume message based at least in part on one or more parameters associated with the registration pending message, as described above.

As further shown in FIG. 7, in some aspects, process 700 may include receiving a registration accept message or a registration reject message (block 750). For example, the UE (e.g., using communication manager 908 and/or reception component 902 depicted in FIG. 9) may receive a registration accept message or a registration reject message, as described above.

Process 700 may include additional aspects, such as any single aspect or any combination of aspects described below and/or in connection with one or more other processes described elsewhere herein.

In a first aspect, the one or more parameters indicate a time duration to wait before transmitting the registration resume message, and transmitting the registration resume message includes transmitting the registration resume message after waiting the time duration.

In a second aspect, alone or in combination with the first aspect, process 700 includes starting a timer that is set to the time duration, where transmitting the registration resume message includes transmitting the registration resume message based at least in part on expiration of the timer.

In a third aspect, alone or in combination with one or more of the first and second aspects, the registration request message indicates that the registration pending state is acceptable by the UE.

In a fourth aspect, alone or in combination with one or more of the first through third aspects, the one or more parameters indicate a reason for the registration pending message.

In a fifth aspect, alone or in combination with one or more of the first through fourth aspects, the registration resume message includes a first identifier for the UE that is associated with a second identifier for the UE.

In a sixth aspect, alone or in combination with one or more of the first through fifth aspects, the first identifier is a temporary identifier and the second identifier is a permanent identifier.

In a seventh aspect, alone or in combination with one or more of the first through sixth aspects, the permanent identifier is a subscriber identifier.

In an eighth aspect, alone or in combination with one or more of the first through seventh aspects, the first identifier is specific to the registration resume message.

In a ninth aspect, alone or in combination with one or more of the first through eighth aspects, the second identifier is specific to the registration request message.

In a tenth aspect, alone or in combination with one or more of the first through ninth aspects, process 700 includes displaying an indication of the registration pending state during the registration pending state.

In an eleventh aspect, alone or in combination with one or more of the first through tenth aspects, the registration pending message includes an attach pending message, the registration pending state includes an attach pending state, and/or the registration resume message includes an attach resume message. In some aspects, a registration request message includes an attach request message, a registration accept message includes an attach accept message, a registration reject message includes an attach reject message, and/or a registration complete message includes an attach complete message.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by an NTN entity, in accordance with the present disclosure. Example process 800 is an example where the NTN entity (e.g., a base station 110, a network entity, satellite 420/440, NTN entity 510) performs operations associated with using a registration pending state.

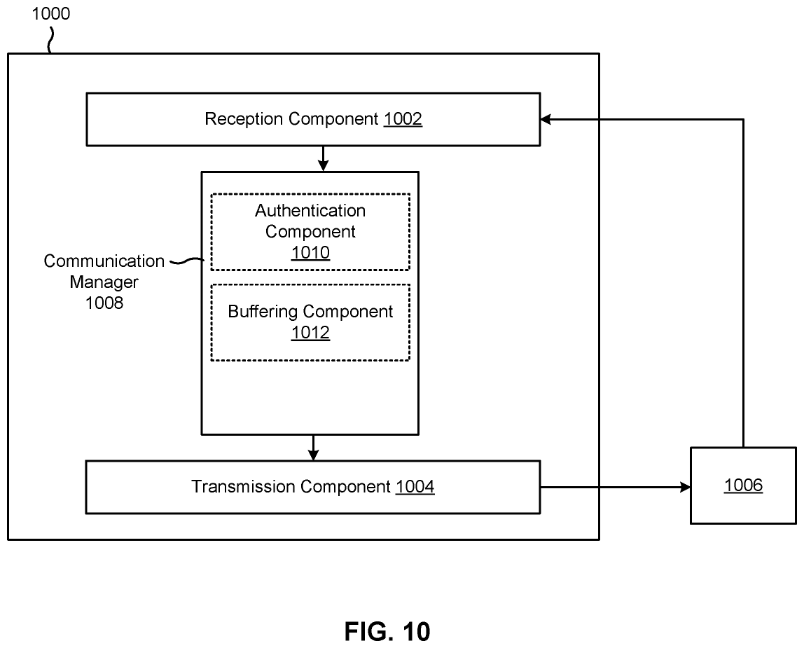

As shown in FIG. 8, in some aspects, process 800 may include receiving a registration request message from a UE (block 810). For example, the NTN entity (e.g., using communication manager 1008 and/or reception component 1002 depicted in FIG. 10) may receive a registration request message from a UE, as described above.

As further shown in FIG. 8, in some aspects, process 800 may include transmitting a registration pending message (block 820). For example, the NTN entity (e.g., using communication manager 1008 and/or transmission component 1004 depicted in FIG. 10) may transmit a registration pending message, as described above.

As further shown in FIG. 8, in some aspects, process 800 may include performing an authentication procedure for the UE with a terrestrial network entity (block 830). For example, the NTN entity (e.g., using communication manager 1008 and/or authentication component 1010 depicted in FIG. 10) may perform an authentication procedure for the UE with a terrestrial network entity, as described above.

As further shown in FIG. 8, in some aspects, process 800 may include receiving a registration resume message from the UE (block 840). For example, the NTN entity (e.g., using communication manager 1008 and/or reception component 1002 depicted in FIG. 10) may receive a registration resume message from the UE, as described above.

As further shown in FIG. 8, in some aspects, process 800 may include transmitting a registration accept message or a registration reject message based at least in part on whether the UE is authenticated (block 850). For example, the NTN entity (e.g., using communication manager 1008 and/or transmission component 1004 depicted in FIG. 10) may transmit a registration accept message or a registration reject message based at least in part on whether the UE is authenticated, as described above.

Process 800 may include additional aspects, such as any single aspect or any combination of aspects described below and/or in connection with one or more other processes described elsewhere herein.

In a first aspect, the registration request message indicates that the registration pending state is acceptable by the UE.

In a second aspect, alone or in combination with the first aspect, the registration pending message includes one or more parameters that indicate an expected time duration until the registration resume message is received.

In a third aspect, alone or in combination with one or more of the first and second aspects, the expected time duration is associated with a duration of a time window between consecutive flyovers of the NTN entity over a location of a ground station.

In a fourth aspect, alone or in combination with one or more of the first through third aspects, process 800 includes buffering messages for the UE between transmitting the registration pending message and transmitting the registration accept message or the registration reject message.

In a fifth aspect, alone or in combination with one or more of the first through fourth aspects, process 800 includes transmitting a registration pending indication in response to receiving a request to connect to the UE from another UE between transmitting the registration pending message and transmitting the registration accept message or the registration reject message.

In a sixth aspect, alone or in combination with one or more of the first through fifth aspects, transmitting the registration pending message includes creating a record of the UE in a database, associating the record of the UE with a registration pending state, creating a first identifier for the UE that is associated with a second identifier for the UE, and associating the record of the UE with the first identifier of the UE.

In a seventh aspect, alone or in combination with one or more of the first through sixth aspects, the registration resume message includes a first identifier for the UE that is associated with a second identifier for the UE and that is specific to the registration resume message, and process 800 includes identifying the UE based at least in part on the first identifier.

In an eighth aspect, alone or in combination with one or more of the first through seventh aspects, identifying the UE includes retrieving a record of the UE from a database based at least in part on the first identifier.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE (e.g., a UE 120, UE 520), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, a network entity, an NTN entity, or another wireless communication device) using the reception component 902 and the transmission component 904. As further shown, the apparatus 900 may include the communication manager 908. The communication manager 908 may control and/or otherwise manage one or more operations of the reception component 902 and/or the transmission component 904. In some aspects, the communication manager 908 may include one or more antennas, a modem, a controller/processor, a memory, or a combination thereof, of the UE described in connection with FIG. 2. The communication manager 908 may be, or be similar to, the communication manager 908 depicted in FIGS. 1 and 2. For example, in some aspects, the communication manager 908 may be configured to perform one or more of the functions described as being performed by the communication manager 908. In some aspects, the communication manager 908 may include the reception component 902 and/or the transmission component 904. The communication manager 908 may include one or more of a registration pending component 910, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The transmission component 904 may transmit a registration request message. The reception component 902 may receive a registration pending message. The registration pending component 910 may enter a registration pending state. The transmission component 904 may transmit a registration resume message based at least in part on one or more parameters associated with the registration pending message. The reception component 902 may receive a registration accept message or a registration reject message.

The registration pending component 910 may start a timer that is set to the time duration, and the transmission component 904 may transmit the registration resume message based at least in part on expiration of the timer. The registration pending component 910 may display an indication of the registration pending state during the registration pending state.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be an NTN entity (e.g., base station 110, satellite 420/440, NTN entity 510), or an NTN entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, a ground station, a network entity, an NTN entity, a relay station, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the network entity described in connection with FIG. 2. The communication manager 1008 may be, or be similar to, the communication manager 150 depicted in FIGS. 1 and 2. For example, in some aspects, the communication manager 1008 may be configured to perform one or more of the functions described as being performed by the communication manager 150. In some aspects, the communication manager 1008 may include the reception component 1002 and/or the transmission component 1004. The communication manager 1008 may include an authentication component 1010 and/or a buffering component 1012, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the NTN entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the NTN entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the NTN entity described in connection with FIG. 2. In some aspects, the transmission component 1004 may be co-located with the reception component 1002 in a transceiver.

The reception component 1002 may receive a registration request message from a UE. The transmission component 1004 may transmit a registration pending message. The authentication component 1010 may perform an authentication procedure for the UE with a terrestrial network entity. The reception component 1002 may receive a registration resume message from the UE. The transmission component 1004 may transmit a registration accept message or a registration reject message based at least in part on whether the UE is authenticated.

The buffering component 1012 may buffer messages for the UE between transmission of the registration pending message and transmission of the registration accept message or the registration reject message. The transmission component 1004 may transmit a registration pending indication in response to receiving a request to connect to the UE from another UE between transmission of the registration pending message and transmission of the registration accept message or the registration reject message.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting a registration request message; receiving a registration pending message; entering a registration pending state; transmitting a registration resume message based at least in part on one or more parameters associated with the registration pending message; and receiving a registration accept message or a registration reject message.

Aspect 2: The method of Aspect 1, wherein the one or more parameters indicate a time duration to wait before transmitting the registration resume message, and wherein transmitting the registration resume message includes transmitting the registration resume message after waiting the time duration.

Aspect 3: The method of Aspect 2, further comprising starting a timer that is set to the time duration, wherein transmitting the registration resume message includes transmitting the registration resume message based at least in part on expiration of the timer.

Aspect 4: The method of any of Aspects 1-3, wherein the registration request message indicates that the registration pending state is acceptable by the UE.

Aspect 5: The method of any of Aspects 1-4, wherein the one or more parameters indicate a reason for the registration pending message.

Aspect 6: The method of any of Aspects 1-5, wherein the registration resume message includes a first identifier for the UE that is associated with a second identifier for the UE.

Aspect 7: The method of Aspect 6, wherein the first identifier is a temporary identifier and the second identifier is a permanent identifier.

Aspect 8: The method of Aspect 7, wherein the permanent identifier is a subscriber identifier.

Aspect 9: The method of Aspect 6, where the first identifier is specific to the registration resume message.

Aspect 10: The method of Aspect 6, where the second identifier is specific to the registration request message.

Aspect 11: The method of any of Aspects 1-10, further comprising displaying an indication of the registration pending state during the registration pending state.

Aspect 12: The method of any of Aspects 1-11, wherein the registration pending message includes an attach pending message, the registration pending state includes an attach pending state, and the registration resume message includes an attach resume message

Aspect 13: A method of wireless communication performed by a non-terrestrial network entity, comprising: receiving a registration request message from a user equipment (UE); transmitting a registration pending message; performing an authentication procedure for the UE with a terrestrial network entity; receiving a registration resume message from the UE; and transmitting a registration accept message or a registration reject message based at least in part on whether the UE is authenticated.

Aspect 14: The method of Aspect 13, wherein the registration request message indicates that the registration pending state is acceptable by the UE.

Aspect 15: The method of Aspect 13 or 14, wherein the registration pending message includes one or more parameters that indicate an expected time duration until the registration resume message is received.

Aspect 16: The method of Aspect 15, wherein the expected time duration is associated with a duration of a time window between consecutive flyovers of the non-terrestrial network entity over a location of a ground station.

Aspect 17: The method of any of Aspects 13-16, further comprising buffering messages for the UE between transmitting the registration pending message and transmitting the registration accept message or the registration reject message.

Aspect 18: The method of any of Aspects 13-17, further comprising transmitting a registration pending indication in response to receiving a request to connect to the UE from another UE between transmitting the registration pending message and transmitting the registration accept message or the registration reject message.

Aspect 19: The method of any of Aspects 13-18, wherein transmitting the registration pending message includes: creating a record of the UE in a database; associating the record of the UE with a registration pending state; creating a first identifier for the UE that is associated with a second identifier for the UE; and associating the record of the UE with the first identifier of the UE.

Aspect 20: The method of any of Aspects 13-19, wherein the registration resume message includes a first identifier for the UE that is associated with a second identifier for the UE and that is specific to the registration resume message, and wherein the method further comprises identifying the UE based at least in part on the first identifier.

Aspect 21: The method of Aspect 20, wherein identifying the UE includes retrieving a record of the UE from a database based at least in part on the first identifier.

Aspect 22: An apparatus for wireless communication at a device, comprising a processor; memory coupled with the processor; and instructions stored in the memory and executable by the processor to cause the apparatus to perform the method of one or more of Aspects 1-21.

Aspect 23: A device for wireless communication, comprising a memory and one or more processors coupled to the memory, the one or more processors configured to perform the method of one or more of Aspects 1-21.

Aspect 24: An apparatus for wireless communication, comprising at least one means for performing the method of one or more of Aspects 1-21.

Aspect 25: A non-transitory computer-readable medium storing code for wireless communication, the code comprising instructions executable by a processor to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit a registration request message;
receive a registration pending message;
enter a registration pending state;
transmit a registration resume message based at least in part on one or more parameters associated with the registration pending message; and
receive a registration accept message or a registration reject message.

2. The UE of claim 1, wherein the one or more parameters indicate a time duration to wait before transmitting the registration resume message, and wherein the one or more processors, to transmit the registration resume message, are configured to transmit the registration resume message after waiting the time duration.

3. The UE of claim 2, wherein the one or more processors are configured to start a timer that is set to the time duration, wherein the one or more processors, to transmit the registration resume message, are configured to transmit the registration resume message based at least in part on expiration of the timer.

4. The UE of claim 1, wherein the registration request message indicates that the registration pending state is acceptable by the UE.

5. The UE of claim 1, wherein the one or more parameters indicate a reason for the registration pending message.

6. The UE of claim 1, wherein the registration resume message includes a first identifier for the UE that is associated with a second identifier for the UE.

7. The UE of claim 6, wherein the first identifier is a temporary identifier and the second identifier is a permanent identifier.

8. The UE of claim 7, wherein the permanent identifier is a subscriber identifier.

9. The UE of claim 6, where the first identifier is specific to the registration resume message.

10. The UE of claim 6, where the second identifier is specific to the registration request message.

11. The UE of claim 1, wherein the one or more processors are configured to display an indication of the registration pending state during the registration pending state.

12. The UE of claim 1, wherein the registration pending message includes an attach pending message, the registration pending state includes an attach pending state, and the registration resume message includes an attach resume message.

13. A non-terrestrial network (NTN) entity for wireless communication, comprising:
a memory; and
one or more processors, coupled to the memory, configured to:
receive a registration request message from a user equipment (UE);
transmit a registration pending message;
perform an authentication procedure for the UE with a terrestrial network entity;
receive a registration resume message from the UE; and
transmit a registration accept message or a registration reject message based at least in part on whether the UE is authenticated.

14. The NTN entity of claim 13, wherein the registration request message indicates that the registration pending state is acceptable by the UE.

15. The NTN entity of claim 13, wherein the registration pending message includes one or more parameters that indicate an expected time duration until the registration resume message is received.

16. The NTN entity of claim 15, wherein the expected time duration is associated with a duration of a time window between consecutive flyovers of the non-terrestrial network entity over a location of a ground station.

17. The NTN entity of claim 13, wherein the one or more processors are configured to buffer messages for the UE between transmission of the registration pending message and transmission of the registration accept message or the registration reject message.

18. The NTN entity of claim 13, wherein the one or more processors are configured to transmit a registration pending indication in response to receiving a request to connect to the UE from another UE between transmission of the registration pending message and transmission of the registration accept message or the registration reject message.

19. The NTN entity of claim 13, wherein the one or more processors, to transmit the registration pending message, are configured to:
create a record of the UE in a database;
associate the record of the UE with a registration pending state;
create a first identifier for the UE that is associated with a second identifier for the UE; and
associate the record of the UE with the first identifier of the UE.

20. The NTN entity of claim 13, wherein the registration resume message includes a first identifier for the UE that is associated with a second identifier for the UE and that is specific to the registration resume message, and wherein the one or more processors are configured to identify the UE based at least in part on the first identifier.

21. The NTN entity of claim 20, wherein the one or more processors, to identify the UE, are configured to retrieve a record of the UE from a database based at least in part on the first identifier.

22. A method of wireless communication performed by a user equipment (UE), comprising:
transmitting a registration request message;
receiving a registration pending message;
entering a registration pending state;
transmitting a registration resume message based at least in part on one or more parameters associated with the registration pending message; and
receiving a registration accept message or a registration reject message.

23. The method of claim 22, wherein the one or more parameters indicate a time duration to wait before transmitting the registration resume message, and wherein transmitting the registration resume message includes transmitting the registration resume message after waiting the time duration.

24. The method of claim 22, wherein the registration request message indicates that the registration pending state is acceptable by the UE.

25. The method of claim 22, wherein the registration resume message includes a first identifier for the UE that is associated with a second identifier for the UE, wherein the first identifier is a temporary identifier and the second identifier is a permanent identifier.

26. The method of claim 22, further comprising displaying an indication of the registration pending state during the registration pending state.

27. A method of wireless communication performed by a non-terrestrial network entity, comprising:
receiving a registration request message from a user equipment (UE);
transmitting a registration pending message;
performing an authentication procedure for the UE with a terrestrial network entity;
receiving a registration resume message from the UE; and
transmitting a registration accept message or a registration reject message based at least in part on whether the UE is authenticated.

28. The method of claim 27, wherein the registration pending message includes one or more parameters that indicate an expected time duration until the registration resume message is received, and wherein the expected time duration is associated with a duration of a time window between consecutive flyovers of the non-terrestrial network entity over a location of a ground station.

29. The method of claim 27, wherein transmitting the registration pending message includes:
creating a record of the UE in a database;
associating the record of the UE with a registration pending state;
creating a first identifier for the UE that is associated with a second identifier for the UE; and
associating the record of the UE with the first identifier of the UE.

30. The method of claim 29, wherein the method further comprises identifying the UE by retrieving the record of the UE from the database based at least in part on the first identifier.
